(19) United States
(12) Patent Application Publication
(10) Pub. No.: US 2011/0054985 A1
(43) Pub. Date: Mar. 3, 2011

(54) ASSESSING A COMMUNICATION STYLE OF A PERSON TO GENERATE A RECOMMENDATION CONCERNING COMMUNICATION BY THE PERSON IN A PARTICULAR COMMUNICATION ENVIRONMENT

(75) Inventors: Ronald Albert Ricci, Los Gatos, CA (US); Tracy Jo Garroutte, Morgan Hill, CA (US); Erin Bergamo Tacy, Los Altos, CA (US)

(73) Assignee: Cisco Technology, Inc., San Jose, CA (US)

(21) Appl. No.: 12/547,404

(22) Filed: Aug. 25, 2009

(51) Int. Cl. G06Q 10/00; G06Q 99/00; G06Q 50/00

(52) U.S. Cl. 705/11; 705/7; 705/1.1; 705/321

(57) ABSTRACT

In one embodiment, a method includes accessing a set of responses to an instrument for assessing a communication style of a person; based on the set of responses to the instrument, determining a communication profile of the person that indicates how the person mentally processes information, how the person mentally organizes information, how comfortable the person is at expressing himself or herself, and whether the person presents information in a more linear manner or a more nonlinear manner; based on the communication profile of the person, generating a recommendation concerning communication by the person in a particular communication environment; and communicating the recommendation for consideration.

### TECHNICAL FIELD

This disclosure relates generally to applied psychometrics.

### BACKGROUND

Psychometrics is the theory and technique of educational and psychological measurement, which may include the measurement of knowledge, abilities, attitudes, and personality traits. It concerns the study of measurement instruments—such as, for example, questionnaires and tests—and involves the development of instruments and procedures for such measurement and the development and refinement of theoretical approaches to such measurement. Tools in the field of psychometrics for personality testing include the Myers-Briggs Type Indicator (MBTI) assessment, which is a psychometric questionnaire designed to measure psychological preferences in how people perceive the world and make decisions. The Personality and Preference Inventory (PAPI) is another tool for personality testing, designed to elicit behaviors and preferences that are appropriate to the workplace. The Herrmann Brain Dominance Instrument (HBDI) is yet another tool for personality testing, measuring and describing thinking preferences in people.

To become better or more effective presenters, public speakers, or communicators, people may read books, take classes, or receive coaching or instruction on how to do so.

### BRIEF DESCRIPTION OF THE DRAWINGS

FIG. 1 illustrates an example system for assessing a communication style of a person to generate a recommendation concerning communication by the person in a particular communication environment.

FIG. 2 illustrates an example communication model.

FIG. 3 illustrates example graphics to facilitate explanation of a communication style of a person.

FIG. 4 illustrates an example communication-environment model.

FIG. 5 illustrates an example method for assessing a communication style of a person to generate a recommendation concerning communication by the person in a particular communication environment.

FIG. 6 illustrates an example computer system.

### DESCRIPTION OF EXAMPLE EMBODIMENTS

Overview

In one embodiment, a method includes accessing a set of responses to an instrument for assessing a communication style of a person; based on the set of responses to the instrument, determining a communication profile of the person that indicates how the person mentally processes information, how the person mentally organizes information, how comfortable the person is at expressing himself or herself, and whether the person presents information in a more linear manner or a more nonlinear manner; based on the communication profile of the person, generating a recommendation concerning communication by the person in a particular communication environment; and communicating the recommendation for consideration.

Description

Particular embodiments use an online tool to identify communication modalities to improve collaboration and communication behaviors by people. Particular embodiments make recommendations for different types of presenters based on their communication styles.

Particular embodiments utilize a communication model that focuses specifically on eight different communication modalities. In particular embodiments, this communication model identifies the degree to which each modality affects the communication style and collaborative behavior of a person. When identifying communication styles, particular embodiments present the relevant information on one or more linear scales and recommend how to communicate with a person on a different part of each of one or more of the linear scales. Particular embodiments make recommendations for identifying audience styles and managing or bridging a person's communication style with others.

Particular embodiments utilize a communication model that includes eight communication modalities, with a collective focus on how a person organizes thoughts, expresses himself or herself, and applies his or her natural tendencies when communicating. Particular embodiments identify communication environments that a person will be more effective in, as well as how the person can bridge his or her communication style to be more effective with his or her audience.

Particular embodiments facilitate online assessment (in contrast to a live course with an instructor) of a communication style of a person. To assess a communication style of a person, particular embodiments focus on (1) how the person organizes his or her thoughts, e.g., conceptual versus analytical and inductive versus deductive; (2) how the person expresses himself or herself, e.g. extrovert versus introvert and linear versus nonlinear; and (3) how the person can apply his or her natural tendencies to his or her communication style and identify how to be more effective in different situations. Particular embodiments facilitate connecting the communication style of a person to audience “cues” and provide bridging recommendations on how to be more effective with a particular audience, which may include one or more people. Particular embodiments take into account the type of communication environment, such as, for example, the purpose of a meeting, e.g., to inform, to engage, to exchange, to influence, to collaborate, or to sell.

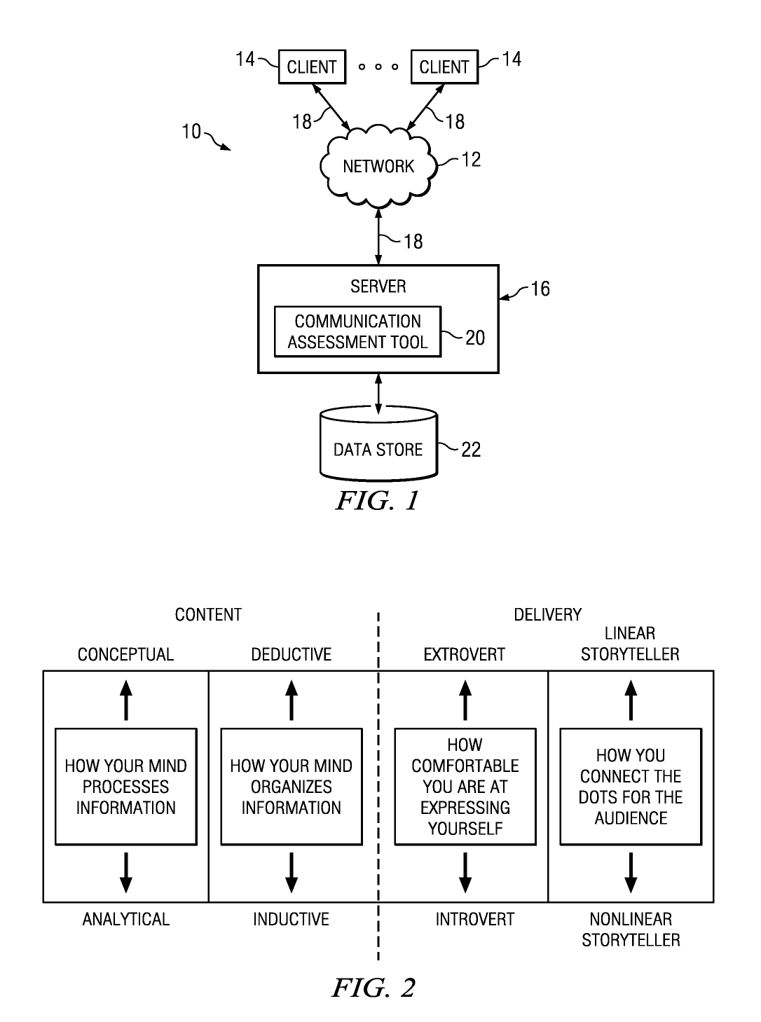

FIG. 1 illustrates an example system 10 for assessing a communication style of a person to generate a recommendation concerning communication by the person in a particular communication environment. System 10 includes a network 12 coupling one or more clients 14 and a server 16 to each other. In particular embodiments, network 12 is an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or another network 102 or a combination of two or more such networks 12. Network 12 may include one or more networks 12. The present disclosure contemplates any suitable network 12. Links 18 couple clients 14 and server 16 to network 12. In particular embodiments, one or more links each include one or more wireline, wireless, or optical links. In particular embodiments, one or more links 18 each include an ad hoc network, an intranet, an extranet, a VPN, a LAN, a WLAN, a WAN, a WWAN, a MAN, a portion of the Internet, a portion of the PSTN, a cellular telephone network, or another link 18 or a combination of two or more such links 18. A link 18 may include one or more links 18. The present disclosure contemplates any suitable links 18. Links 18 need not necessarily be the same throughout system 10. One or more first links 18 may differ in one or more respects from one or more second links 18.

A client 14 may enable a person at client 14 to interact with or otherwise access one or more services at server 16, interact with or otherwise communicate with one or more other persons at one or more other clients 14, or perform other actions, which may, but need not necessarily, involve communicating via network 12. As an example and not by way of limitation, a client 14 may enable a person at client 14 to send or receive e-mail or instant messages (IMs), access and interact with Web pages (which one or more Web servers coupled to network 12 may host), or access and interact with one or more applications hosted by server 16. Example clients 14 include, but are not necessarily limited to, workstations, notebook computer systems, desktop computer systems, tablet computer systems, personal digital assistants (PDAs), mobile telephones, and other clients 14. A client 14 may be internal or external to network 12 and may be directly or indirectly coupled to network 12. A client 14 may include one or more clients 14. The present disclosure contemplates any suitable clients 14. A client 14 may communicate with server 16, one or more other clients 14, or both via network 12 using one or more particular communication protocols, according to particular needs. The present disclosure contemplates any suitable communication protocols for communicating via network 12.

Server 16 may host one or more applications that one or more clients 14 may access and interact with, and communication assessment tool 20 residing at server 16 may provide one or more of those applications, as described below. Server 16 may be internal or external to network 12 and may be directly or indirectly coupled to network 12. Server 16 may be unitary or distributed across multiple computer systems or datacenters, according to particular needs. Server 16 may include one or more servers 16. The present disclosure contemplates any suitable server 16. In particular embodiments server 16 includes one or more servers or other computer systems for hosting web pages or particular elements of web pages. As an example and not by way of limitation, server 16 may host Hyper Text Markup Language (HTML) or other files, or may dynamically create or constitute files on a request, and communicate them to clients 14 in response to Hyper Text Transfer Protocol (HTTP) or other requests from clients 14. In particular embodiments, a web browser at a client 14 may render a web page from one or more HTML files received from server 16. In particular embodiments, server 16 may render a web page and then serve the rendered web page to a client 14 for display.

Data store 22 contains data for server 16. Server 16 may read from and write to data store 22 as needed to perform its functions, as described below. As an example and not by way of limitation, in particular embodiments, data store 22 may store HTML or other files for server 16 to communicate to one or more clients 14. Herein, reference to a file may encompass data, regardless of its format, and vice versa, where appropriate. The present disclosure contemplates any suitable format for any suitable data. The present disclosure contemplates any suitable data store 22. In particular embodiments, data store 22 includes one or more databases and one or more database management systems. Data store 22 may be internal or external to server 16. In particular embodiments, one or more links 18 couple server 16 to data store 22. Data store 22 may include one or more data stores 22.

In particular embodiments, communication assessment tool 20 includes a hardware or software component or a combination of two or more such components for assessing a communication style of a person to generate a recommendation concerning communication by the person in a particular communication environment. As an example and not by way of limitation, a person at a client 14 may navigate through a Web browser at client 14 to server 16. Server 16 may communicate to client 14 a Web page that provides access to communication assessment tool 20. Server 16 may, but need not necessarily, require the person to provide a valid user name and password (or name and valid e-mail address) before allowing the person to access communication assessment tool 20. Through the Web page, the person may request an assessment by communication assessment tool 20. In response, communication assessment tool 20 may generate a measurement instrument (or instrument) for assessing a communication style of the person. As an example and not by way of limitation, the instrument may include a set of questions for the person to answer or a set of statements for the person to indicate agreement or disagreement (or a level of agreement or disagreement) with, as described below. Herein, reference to a question for a person to answer may encompass a statement for the person to indicate agreement or disagreement (or a level of agreement or disagreement) with, and vice versa, where appropriate. Data store 22 may store the questions or statements. To generate an instrument, communication assessment tool 20 may access questions or statements in data store 22. The questions or statements may be in one or more HTML or other files in data store 22. Communication assessment tool 20 may access the HTML or other files (or, based on them, dynamically create or constitute files for communication to client 14) in response to the request from the person and communicate the files to client 14 for presentation as an instrument to the person.

Client 14 may receive the files and, based on the files, present to the person a user interface (UI) for responding to the instrument, which client 14 may do through a Web browser at client 14. The client 14 may present the instrument to the person as a series of pages that each contain one or more statements, with a place next to each for the person to indicate (such as, for example, by clicking on or otherwise selecting a particular icon) whether he or she strongly disagrees, disagrees, agrees, or strongly agrees with it. One or more introductory pages may precede the pages presenting the instrument to the person. The introductory pages may provide instructions to the person. As an example and not by way of limitation, the introductory pages may include instructions such as the following:
The assessment should only take 5-8 minutes to complete, so please answer all the questions.
When answering the questions, think about what is most comfortable for you vs. what you do to adapt to your environment or what you do to succeed in your job.
The first answer that comes to mind usually represents your authentic and natural communication style.
   Particular embodiments may present one or more instructions that are differently worded, but substantively similar, to one or more of the instructions above. Although the present disclosure describes presenting particular instructions, the present disclosure contemplates presenting any suitable instructions.

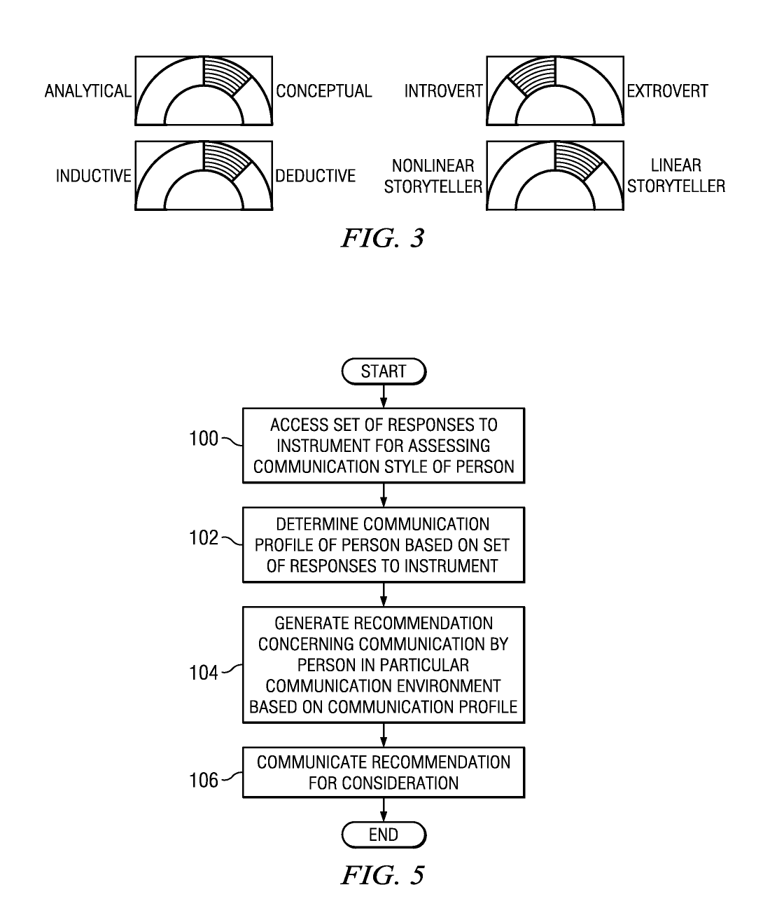

The person may provide responses to the questions or statements in the instrument through client 14 and submit them (or otherwise cause them to be communicated) to communication assessment tool 20. Communication assessment tool 20 may receive the responses and then analyze them. Through the analysis, communication assessment tool 20 may identify a communication style of the person as defined by a communication model. FIG. 2 illustrates an example communication model. In particular embodiments the communication model includes eight communication modalities, with a collective focus on how a person organizes thoughts, expresses himself or herself, and applies his or her natural tendencies when communicating. As an example and not by way of limitation, the eight modalities may be (1) extrovert or (2) introvert; (3) analytical or (4) conceptual; (5) inductive or (6) deductive; and (7) linear or (8) nonlinear. Communication assessment tool 20 may use an algorithm to assign four of these modalities (one from each pair) to the person based on the responses to the questions or statements in the instrument. When conveying the communication style of the person determined by communication assessment tool 20, communication assessment tool 20 may represent each of the assigned modalities on a linear scale. FIG. 3 illustrates example graphics to facilitate explanation of a communication style of a person. In FIG. 3, the shaded area in each graphic shows where the natural tendencies of the person lie along the dimension corresponding to the graphic. If the top of the graphic is shaded, the results are moderate along the corresponding dimension. If the bottom of the graphic is shaded on either side, the results are stronger in that direction. The communication style conveyed by the graphics in FIG. 3 may be described as moderate conceptual, moderate deductive, moderate introvert, and moderate linear.

Particular embodiments treat each pair of modalities (extrovert or introvert; analytical or conceptual; inductive or deductive; and linear or nonlinear) as a dimension. The extrovert/introvert dimension may correspond to how the person mentally processes information. The analytical/conceptual dimension may correspond to how the person mentally organizes information. The inductive/deductive dimension may correspond to how comfortable the person is at expressing himself or herself. The linear/nonlinear dimension may correspond to how the person tends to connect the dots for his or her audience. In particular embodiments, the analytical/conceptual and inductive/deductive dimensions make up a content segment of the communication model concerning the content that the person communicates to his or her audience. In particular embodiments, the extrovert/introvert and linear/nonlinear dimensions make up a delivery segment of the communication model concerning the delivery of the content that the person communicates to his or her audience.

Particular embodiments may define or describe an extroverted communication style as follows. As an extrovert, the person may be disposed to being open, sociable, and talkative and may be energized by working with others. The person may be comfortable facilitating groups and meetings and may tend to contribute fully whether the person is facilitating or not. The person may gain energy and mental stimulation from being with other people. The person may like working in a social environment, examining issues, and developing options as part of an interactive group process. Others people may look to the person to “warm up” a group situation or to take charge of a meeting. The person may be comfortable thinking on his or her feet. The person may have a tendency to become so excited and involved that at times he or she shuts out contributions from other people without meaning to, which may cause those people to become resentful or give up trying to offer their own ideas. Natural communication strengths of the person may be that he or she gains energy and mental stimulation from being with other people; is comfortable working in a social environment and likes to examine issues and develop options as part of an interactive group process; tends to take command of discussions; and can help to “warm up” a new group of people so they can begin to work together more effectively. To increase his or her effectiveness as a communicator (depending in particular embodiments on the particular communication environment) it may be advisable for the person to avoid always being the first to contribute in groups or meetings; to allow others to jump in; to listen to, solicit, and acknowledge others' ideas; not to let his or her enthusiasm for his or her own ideas overshadow other people's contributions; to consider sharing his or her extrovert dimension with his or her audience (such as, for example, “I can get pretty excited about this stuff, but I want to hear your ideas, so please don't hesitate to jump in”); and to accept that others may not be as comfortable as he or she is in social situations or speaking within groups; to try to identify people who are more introverted when he or she is working in a group and be sure to involve them in ways that give them time to formulate and articulate their response. In particular embodiments, if the person has an extroverted communication style, the communication profile may include one or more portions of the definition or description above or information that is substantively similar to one or more portions of the definition or description above.

Particular embodiments may define or describe an introverted communication style as follows. As an introvert, the person may derive energy from his or her internal thoughts. Although the person may have learned how to work successfully in large groups, the person may tend to believe that he or she does his or her best thinking by himself or herself. The person may prefer communicating via e-mail or one-on-one rather than in a group setting. In group discussions, the person may be less inclined to make comments than to track closely to what other people are saying and formulate his or her own thoughts. He or she may want to take time after a group discussion to process what transpired and develop a thoughtful perspective. Natural communication strengths of the person may be that he or she has an ability to observe and think on his or her own, which may make the person a valuable team member, collaborator, and problem solver; the person can help a team to avoid the groupthink that can drag a group off course; his or her observations may help to shed light on the dynamics that may be preventing a group from performing more effectively; his or her willingness to share the spotlight may make the person an excellent team player, especially if most of the team members are extroverts. To increase his or her effectiveness as a communicator (depending in particular embodiments on the particular communication environment) it may be advisable for the person to reduce his or her discomfort at being the center of attention by planning and rehearsing formal presentations and high-stakes conversations; not to hold back his or her ideas just because nobody asked for them; if asked for a response to a recommendation or plan, to reply in the style of a communication-face-to-face meeting, telephone or e-mail-that he or she feels more comfortable with; to seek out opportunities for collaboration with an extrovert-doing the research and drawing up recommendations, for example, and then partnering with the extrovert to make the presentation; to share his or her introvert dimension with his or her audience by saying, for example, “I like to take in all the data and think about it for a while before I respond”; and to avoid implying that his or her way is the best way. In particular embodiments, if the person has an introverted communication style, the communication profile may include one or more portions of the definition or description above or information that is substantively similar to one or more portions of the definition or description above.

In particular embodiments, if the person has an introverted communication style, in addition or as an alternative to one or more portions of the definition or description above or information that is substantively similar to one or more portions of the definition or description above, the communication profile may include one or more recommendations for managing or bridging the communication style of the person with one or more people who have extroverted communication styles. As an example and not by way of limitation, the communication profile may state that extroverts are energized by working with others; that they are comfortable speaking off the cuff and thinking on their feet; that, in groups or meetings, they tend to contribute whether or not they are facilitating; and that they may get so excited and involved that they shut out contributions from more introverted members without meaning to. In particular embodiments, the communication profile may also provide one or more cues for identifying a person who has an extroverted communication style. As an example and not by way of limitation, the communication profile may indicate that an extrovert may say things like, “If we put our heads together, I'm sure we can solve the problem.”; “Let me throw some ideas out there to get things started.”; “If no one else wants to go first, let me give you my thinking.”; “I'm just thinking out loud here, but what if . . . ?”

Particular embodiments may define or describe an analytical communication style as follows. As an analytical processor of information, the person may think in terms of logical narratives, facts, step-by-step processes, equations, formulas, and if-then scenarios. The person may usually get straight to the point when communicating and help his or her colleagues to focus on the tactics and tasks required to achieve goals or objectives. The person may communicate well with technical professionals and in situations calling for a methodical approach to solving complex problems. The person may also be effective in resolving very emotional disagreements by helping the people involved focus on the facts. The person may tend not to think in terms of intuition-his or her own intuition or the intuition of other people-or judgments that are not supported by clear-cut facts. The person may be less comfortable with unstructured mental processes, like brainstorming. Natural communication strengths of the person may be that he or she seeks out data when solving problems; likes to investigate issues thoroughly; tends to break problems into pieces; can also manage large projects by dividing them into logical chunks; and tends to dissect issues to create action plans. To increase his or her effectiveness as a communicator (depending in particular embodiments on the particular communication environment) it may be advisable for the person to be alert to those times when he or she should focus on the big-picture benefits of his or her thinking (such as, for example, when trying to influence others); not to automatically dismiss ideas of other people, even when their ideas are not fully supported by data; to keep in mind that judgment and experience (his or her own judgment and the judgment of other people) can be very valuable, even if they cannot always be quantified; and, because of a possible tendency to over-analyze a problem or situation, keeping him or her from making a timely decision, to be aware of when he or she is “stuck in the weeds” and losing the interest of his or her audience. In particular embodiments, if the person has an analytical communication style, the communication profile may include one or more portions of the definition or description above or information that is substantively similar to one or more portions of the definition or description above.

Particular embodiments may define or describe a conceptual communication style as follows. As a conceptual communicator, the person may have a natural preference to think in terms of concepts, ideas, and possibilities instead of logic and facts. The person may be comfortable using intuition and gut feelings and dealing with problems without a lot of available data. The person may often see the whole without focusing too much on the missing parts. Natural communication strengths of the person may be that he or she tends to see the big-picture possibilities of a situation, which may make the person a valuable team member, collaborator, and problem solver; his or her ideas may help a group see a future state to work towards; the person may help other people to see potentially useful connections among apparently unrelated facts and situations; the person may tend to make good use of intuition-the intuition of himself or herself and the intuition of other people; and the person may tend to advance a process by integrating information into theories and hypotheses that suggest a course of action. To increase his or her effectiveness as a communicator (depending in particular embodiments on the particular communication environment) it may be advisable for the person to be alert to those times when other people are getting impatient with his or her bit-picture message and want to ground it in real data; to recognize that his or her high-level concepts and ideas usually benefit from a more analytical person's questions of fact and process; when planning a presentation or high-stakes conversation, to include more data than he or she might think is necessary so that he or she can respond to questions that a more analytical person might have; if possible, to supply fact sheets with information that a more analytical person may look for; to tell other people that he or she tends to approach things conceptually, without giving the impression that this is the “best” way; to strive to get his or her differences out on the table where all concerned people can see them and make adjustments accordingly. In particular embodiments, if the person has an analytical communication style, the communication profile may include one or more portions of the definition or description above or information that is substantively similar to one or more portions of the definition or description above.

In particular embodiments, if the person has a conceptual communication style, in addition or as an alternative to one or more portions of the definition or description above or information that is substantively similar to one or more portions of the definition or description above, the communication profile may include one or more recommendations for managing or bridging the communication style of the person with one or more people who have analytical communication styles. As an example and not by way of limitation, the communication profile may state that analytical people want to nail down the logic and facts of a given situation that they can be frustrated by what they see as a conceptual person's seeming disregard for these concerns and willingness to proceed without all the facts; and that analytical people are less likely than conceptual thinkers to want to use brainstorming or to trust the results of brainstorming. In particular embodiments, the communication profile may also provide one or more cues for identifying a person who has an analytical communication style. As an example and not by way of limitation, the communication profile may indicate that an analytical person may say things like, “Let's think about how to quantify these ideas, so that we'll know if we are making progress.”; “If we can stick to this process, we'll be golden.”; “I like what you're saying. It's very logical.”; “I think it's time to narrow down these possibilities to a few viable solutions.”

Particular embodiments may define or describe a deductive communication style as follows. As a deductive communicator, the person may tend to organize his or her thinking around conclusions, generalities, and principles, and then turn to the observations, facts, and examples to support his or her conclusions. Rather than being guided by the specifics of a situation, he or she may look for general principles and a logical approach to guide his or her thinking in all situations. He or she may tend to apply general principles to reach specific conclusions. His or her preference for organizing thoughts in overarching rules or themes may make the person effective at finding commonalities in different circumstances or contexts. The person may be effective in laying out a situation in broad terms from the top down. The person may tend to become frustrated when dealing with people who cannot articulate broad goals or objectives. The person may frustrate listeners who want to hear the facts before they entertain generalities. The person may find it difficult to apply rules flexibly. Natural communication strengths of the person may be that he or she tends to be guided by overarching rules or themes; can understand a situation from the top down; and searches for the commonalities in different circumstances, situations, or contexts. To increase his or her effectiveness as a communicator (depending in particular embodiments on the particular communication environment) it may be advisable for the person to ask himself or herself whether the goal requires agreement on general principles or if he or she can reach his or her goal more efficiently by simply focusing on the data itself; to guard against ignoring the specifics of a situation that might require making an exception to the rule; and to be patient with people who need to hear the details that support his or her big-picture thinking. In particular embodiments, if the person has a deductive communication style, the communication profile may include one or more portions of the definition or description above or information that is substantively similar to one or more portions of the definition or description above.

In particular embodiments, if the person has a deductive communication style, in addition or as an alternative to one or more portions of the definition or description above or information that is substantively similar to one or more portions of the definition or description above, the communication profile may include one or more recommendations for managing or bridging the communication style of the person with one or more people who have inductive communication styles. As an example and not by way of limitation, the communication profile may state that an inductive person works from the bottom up (instead of from the top down) or from the specific to the general and tends to start by looking at the data and, from the data, forms a general statement of hypothesis. In particular embodiments, the communication profile may also provide one or more cues for identifying a person who has a deductive communication style. As an example and not by way of limitation, the communication profile may indicate that an deductive thinker may say things like, “Let's look at what the data is telling us.”; “We need a way to find out what's going on before we come to any conclusions.”; “Can you set some context on this before you give me your recommendation?”

Particular embodiments may define or describe a linear communication style as follows. As a linear storyteller, the person may utilize a direct, straightforward, ordered sequence in communicating with others. The person may like orderly presentations with no surprises. The person may tend to set out an outline or agenda and follow it closely. If the person uses POWERPOINT slides, he or she may tend to stick to the bullets. The person may tend to be very good at staying focused. He or she may tend to discourage off-topic discussions during a conversation or presentation. This focus may tend to keep everyone on the same page and help them to follow what the person is saying. This dimension of the communication style of the person may mean that he or she is likely to be effective at explaining new procedures or policies or communicating with a group with members who have widely divergent knowledge about the topic. Taken too far, this orderly approach may turn into inflexibility. The person may become resistant or confused when someone asks a question out of order or “too early.” The person may be reluctant to diverge from his or her plan even when circumstances require it. Natural communication strengths of the person may be that he or she tends to stay “on message” and discourage random discussions within the context of a presentation; is usually good at explaining new policies or procedures; stays focused on his or her outline or map to achieve desired results; and is good at making sure that conversations or action items are completed before moving on to a new topic. To increase his or her effectiveness as a communicator (depending in particular embodiments on the particular communication environment) it may be advisable for the person to avoid shutting down constructive participation for fear it will take the person off-course; if his or her train of thought is being interrupted by comments and questions, to consider capturing them on paper and commit to dealing with them later in the meeting; to be aware of how others are responding to him or her and make adjustments to maintain their interest or clarify his or her ideas; and to share the linear dimension of his or her communication style by saying something like, “It helps me if we can start from the beginning and take it step by step. Is that OK?” In particular embodiments, if the person has a linear communication style, the communication profile may include one or more portions of the definition or description above or information that is substantively similar to one or more portions of the definition or description above.

In particular embodiments, if the person has a linear communication style, in addition or as an alternative to one or more portions of the definition or description above or information that is substantively similar to one or more portions of the definition or description above, the communication profile may include one or more recommendations for managing or bridging the communication style of the person with one or more people who have nonlinear communication styles. As an example and not by way of limitation, the communication profile may state that a nonlinear storyteller is comfortable improvising presentations where ideas do not have to connect logically; that, for him or her, understanding occurs in big leaps; and that he or she sees communicating information as a holistic process that relies less on step-wise, straightforward methods, and more on creative, dynamic communication paths. In particular embodiments, the communication profile may also provide one or more cues for identifying a person who has a nonlinear communication style. As an example and not by way of limitation, the communication profile may indicate that a nonlinear storyteller may say things like, “That reminds me of a story someone told me yesterday.”; “What you said makes me think we ought to stop right now and get Carl in here to explain his thinking.”; “Let's play it by ear and see how far we get.”

In particular embodiments, communication assessment tool 20 may generate a communication profile for the person based on the identified communication style. The communication profile may identify the four modalities of the communication style of the person (extrovert or introvert; analytical or conceptual; inductive or deductive; and linear or nonlinear) and, for each one, indicate the strength of the modality in the communication style of the person. As an example, if the modalities of the communication style of the person are introvert, conceptual, deductive, and linear, the communication profile may indicate whether the communication style of the person is strongly or moderately introverted; whether the communication style of the person is strongly or moderately conceptual; whether the communication style of the person is strongly or moderately introverted; and whether the communication style of the person is strongly or moderately linear. The communication profile may include recommendations on how the person can use his or her communication style more effectively in different communication environments, as described below. The communication profile may identify or describe bridging techniques for the person to use when communicate with one or more other people with communications styles different from him or her, as further described below. In particular embodiments, communication assessment tool 20 or another tool may use the communication profile of the person, together with the communication profiles of other people to make recommendations on different speakers for different meetings, teams, or other communication environments or identify preferred skill sets for cross-functional working groups. As an example and not by way of limitation, at the outset of a new project, communication assessment tool 20 or another tool may recommend more conceptual thinkers for brainstorming meetings. Although the present disclosure describes particular information in particular communication profiles, the present disclosure contemplates any suitable information in any suitable communication profiles.

As described above, an instrument for assessing a communication style of a person may include a set of questions for the person to answer. The instrument may, but need not necessarily, present one or more of the questions as statements, asking the person to indicate whether he or she strongly disagrees, disagrees, agrees, or strongly agrees with each one. In particular embodiments, the instrument focuses on (1) how the person processes information, (2) how the person organizes information, (3) how comfortable the person is at expressing himself or herself, and (4) whether the person presents information in a more linear manner or a more nonlinear manner. As an example and not by way of limitation, the instrument may ask the person to indicate whether he or she strongly disagrees, disagrees, agrees, or strongly agrees with each of the following statements:
I am less likely to actively participate in meetings with large numbers of people.
I am really good at anticipating details.
I am very annoyed when I attend meetings that lack a structured agenda.
I enjoy discussing theories and big ideas.
I find conversations not grounded in facts to be a waste of time.
I find it difficult to see the big picture without having all the details.
I like to develop and construct models to help explain my ideas.
I like to see multiple points of data before I will support an idea.
I like to take people down expected paths when presenting or preparing a presentation.
I make decisions based on research and data.
I make my case with evidence to better communicate my ideas.
I need to interact with colleagues or customers on a daily basis to be most productive.
I need to process information and develop ideas alone.
I need to see the big picture before I will support an idea.
I need to understand the big picture before diving into the details.
I need to use guidelines and operating procedures to support my position on issues.
I often lead meetings with a loosely structured agenda.
I prefer communicating in writing (e.g., e-mail, instant messaging).
I prefer to be actively involved in meeting discussions.
I prefer to use a step-by-step process when helping others with their work.
I tend to focus more on the main idea rather than the details.
I trust my gut-level assessment of a situation.
I trust my intuition when solving problems.
I work best alone.
In meetings, I prefer to stay closely focused o the agenda.
In my opinion, meetings or group brainstorms are not as effective as individual efforts.
In preparing for a meeting or presentation, I work hard to anticipate every possible question.
My best ideas come from working with others. My best solutions are based on data and evidence.
When delivering a presentation, I prefer to use a prepared outline.
When I am preparing a presentation I think in logical steps.
When making a recommendation, I like to start with the main idea and then explain the supporting facts.
   Particular embodiments may present one or more statements that are differently worded, but substantively similar, to one or more of the statements above. Particular embodiments may present a statement to the person multiple times to elicit multiple responses to the statement. Particular embodiments may word the statement the same every time when presenting it to the person. Particular embodiments may word the statement differently when presenting it to the person at different times. Although the present disclosure describes presenting particular statements and asking for particular responses to them, the present disclosure contemplates presenting any suitable statements and asking for any suitable responses to them. Moreover, although the present disclosure describes a particular instrument for assessing a communication style of a person, the present disclosure contemplates any suitable instrument for assessing a communication style of a person.

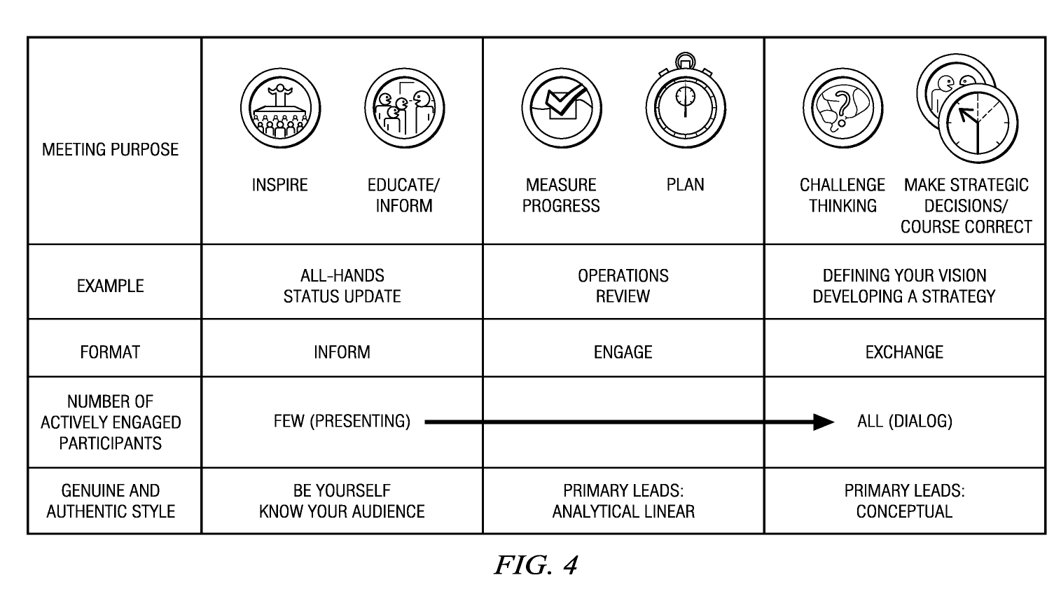

In particular embodiments, when interacting with communication assessment tool 20, the person may provide input specifying one or more communication environments in addition to providing responses to the questions or statements in the instrument. Communication assessment tool 20 may take into account the communication environments specified by the person when generating a recommendation concerning communication by the person. In addition or as an alternative, communication assessment tool 20 may map the communication style of the person to one or more communication environments that the person would tend to be a more effective communicator in. In particular embodiments, a communication environment may be defined by a communication-environment model. FIG. 4 illustrates an example communication-environment model. In the communication-environment model in FIG. 4, the communication environment (or meeting) has a purpose, e.g., to inspire, to educate/inform, to measure progress, to plan, to challenge thinking, or to make strategic decisions/to course correct. The meeting also has a format: to inform; to engage; or to exchange. A communication environment that has a format to inform the audience may tend to have a shorter time allocation (such as, for example, 30 minutes) and an approach that involves more presenting and less discussing (such as, for example, 75% presenting and 25% discussing). A communication environment that has a format to engage the audience may tend to have a medium-length time allocation (such as, for example, one hour) and an approach that involves approximately equal parts presenting and discussing (such as, for example, 50% presenting and 50% discussing). A communication environment that has a format to exchange with or among the audience may tend to have a longer time allocation (such as, for example, two hours) and an approach that involves less presenting and more discussing (such as, for example, 25% presenting and 75% discussing). The communication model may also take into account the number of actively engagement participants.

FIG. 5 illustrates an example method for assessing a communication style of a person to generate a recommendation concerning communication by the person in a particular communication environment. The method starts at step 100, where communication assessment tool 20 accesses a set of responses to an instrument for assessing a communication style of a person. The instrument and the assessment focus on how the person mentally processes information. how the person mentally organizes information, how comfortable the person is at expressing himself or herself, and whether the person presents information in a more linear manner or a more nonlinear manner. At step 102, based on the set of responses to the instrument, communication assessment tool 20 determines a communication profile of the person that indicates how the person mentally processes information. how the person mentally organizes information, how comfortable the person is at expressing himself or herself, and whether the person presents information in a more linear manner or a more nonlinear manner. At step 104, based on the communication profile of the person, communication assessment tool 20 generates a recommendation concerning communication by the person in a particular communication environment. At step 106, communication assessment tool 20 communicates the recommendation for consideration (in particular embodiments by the person whose communication style is being assessed or by one or more other persons) at which point the method ends. Although the present disclosure describes and illustrates particular steps of the method of FIG. 5 as occurring in a particular order, the present disclosure contemplates any suitable steps of the method of FIG. 5 occurring in any suitable order. Although the present disclosure describes and illustrates particular components carrying out particular steps of the method of FIG. 5, the present disclosure contemplates any suitable components carrying out any suitable steps of the method of FIG. 5.

Particular embodiments may be implemented as hardware, software, or a combination of hardware and software. As an example and not by way of limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

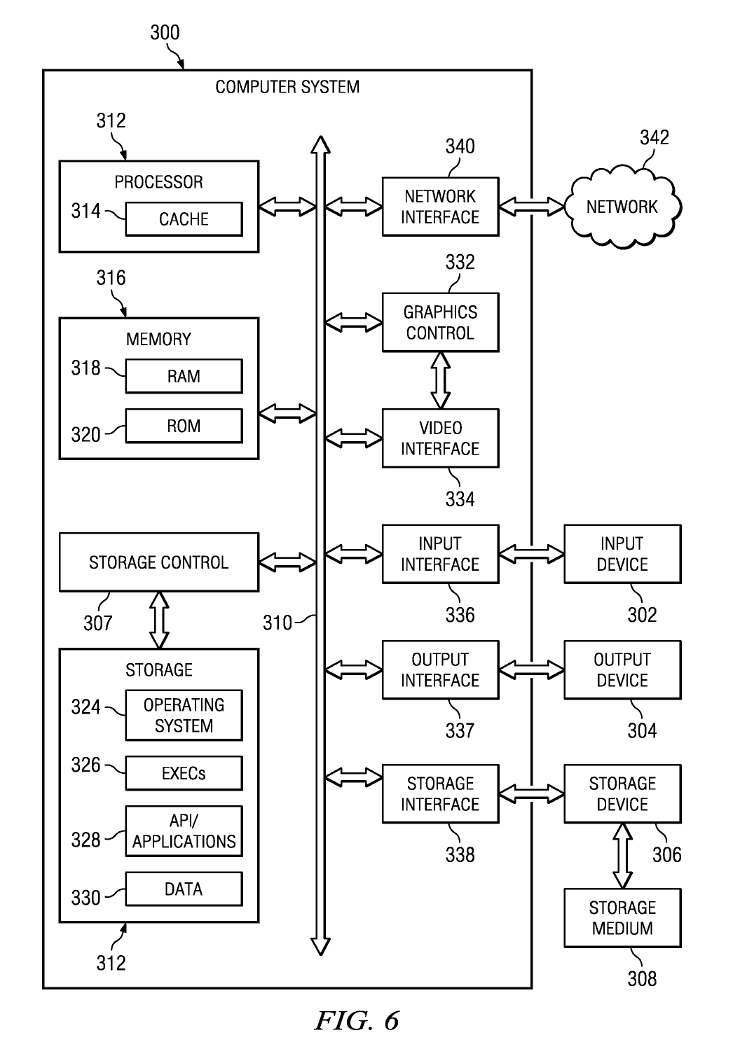

For example, FIG. 6 illustrates an example computer system 300 suitable for implementing one or more portions of particular embodiments. Although the present disclosure describes and illustrates a particular computer system 300 having particular components in a particular configuration, the present disclosure contemplates any suitable computer system having any suitable components in any suitable configuration. Moreover, computer system 300 may have take any suitable physical form, such as for example one or more integrated circuit (ICs), one or more printed circuit boards (PCBs), one or more handheld or other devices (such as mobile telephones or PDAs), one or more personal computers, or one or more super computers.

Computer system 300 may have one or more input devices 302 (which may include a keypad, keyboard, mouse, stylus, etc.), one or more output devices 304 (which may include one or more displays, one or more speakers, one or more printers, etc.), one or more storage devices 306, and one or more storage medium 308. An input device 302 may be external or internal to computer system 300. An output device 304 may be external or internal to computer system 300. A storage device 306 may be external or internal to computer system 300. A storage medium 308 may be external or internal to computer system 300.

System bus 310 couples subsystems of computer system 300 to each other. Herein, reference to a bus encompasses one or more digital signal lines serving a common function. The present disclosure contemplates any suitable system bus 310 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 300 includes one or more processors 312 (or central processing units (CPUs)). A processor 312 may contain a cache 314 for temporary local storage of instructions, data, or computer addresses. Processors 312 are coupled to one or more storage devices, including memory 316. Memory 316 may include random access memory (RAM) 318 and read-only memory (ROM) 320. Data and instructions may transfer bidirectionally between processors 312 and RAM 318. Data and instructions may transfer unidirectionally to processors 312 from ROM 320. RAM 318 and ROM 320 may include any suitable computer-readable storage media.

Computer system 300 includes fixed storage 322 coupled bi-directionally to processors 312. Fixed storage 322 may be coupled to processors 312 via storage control unit 307. Fixed storage 322 may provide additional data storage capacity and may include any suitable computer-readable storage media. Fixed storage 322 may store an operating system (OS) 324, one or more executables (EXECs) 326, one or more applications or programs 328, data 330 and the like. Fixed storage 322 is typically a secondary storage medium (such as a hard disk) that is slower than primary storage. In appropriate cases, the information stored by fixed storage 322 may be incorporated as virtual memory into memory 316.

Processors 312 may be coupled to a variety of interfaces, such as, for example, graphics control 332, video interface 334, input interface 336, output interface 337, and storage interface 338, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 340 may couple processors 312 to another computer system or to network 342. With network interface 340, processors 312 may receive or send information from or to network 342 in the course of performing steps of particular embodiments. Particular embodiments may execute solely on processors 312. Particular embodiments may execute on processors 312 and on one or more remote processors operating together.

In a network environment, where computer system 300 is connected to network 342, computer system 300 may communicate with other devices connected to network 342. Computer system 300 may communicate with network 342 via network interface 340. For example, computer system 300 may receive information (such as a request or a response from another device) from network 342 in the form of one or more incoming packets at network interface 340 and memory 316 may store the incoming packets for subsequent processing. Computer system 300 may send information (such as a request or a response to another device) to network 342 in the form of one or more outgoing packets from network interface 340, which memory 316 may store prior to being sent. Processors 312 may access an incoming or outgoing packet in memory 316 to process it, according to particular needs.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 316 may include one or more computer-readable storage media embodying software and computer system 300 may provide particular functionality described or illustrated herein as a result of processors 312 executing the software. Memory 316 may store and processors 312 may execute the software. Memory 316 may read the software from the computer-readable storage media in mass storage device 316 embodying the software or from one or more other sources via network interface 340. When executing the software, processors 312 may perform one or more steps of one or more processes described or illustrated herein, which may include defining one or more data structures for storage in memory 316 and modifying one or more of the data structures as directed by one or more portions the software, according to particular needs. In addition or as an alternative, computer system 300 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

We claim:

1. A method comprising:
accessing by one or more computer systems a set of responses to an instrument for assessing a communication style of a person, the instrument and the assessment focusing on:
how the person mentally processes information;
how the person mentally organizes information;
how comfortable the person is at expressing himself or herself; and
whether the person presents information in a more linear manner or a more nonlinear manner;
based on the set of responses to the instrument, determining by the one or more computer systems a communication profile of the person that indicates:
how the person mentally processes information;
how the person mentally organizes information;
how comfortable the person is at expressing himself or herself; and
whether the person presents information in a more linear manner or a more nonlinear manner;
based on the communication profile of the person, generating by the one or more computer systems a recommendation concerning communication by the person in a particular communication environment; and
communicating the recommendation for consideration.

2. The method of claim 1, wherein the recommendation is communicated for consideration by the person.

3. The method of claim 1, wherein the recommendation indicates how suited the communication style of the person is to the particular communication environment.

4. The method of claim 1, wherein the recommendation advises how to adapt the communication style of the person to the particular communication environment.

5. The method of claim 1, wherein:
the person is one of a plurality of candidate speakers for the particular communication environment; and
the recommendation advises whether to select the person from among the candidate speakers for the particular communication environment.

6. The method of claim 1, wherein:
the person is one of a plurality of candidate attendees for a particular meeting of a type corresponding to the particular communication environment; and
the recommendation advises whether to select the person from among the candidate attendees to attend the meeting.

7. The method of claim 1, wherein:
the person is one of a plurality of candidate team members for a particular working group using the particular communication environment; and
the recommendation advises whether to select the person from among the candidate team members to be included in the particular working group.

8. The method of claim 1, wherein the communication profile indicates:
with respect to how the person mentally processes information, whether and to what extent the communication style of the person corresponds to a conceptual modality or an analytical modality;
with respect to how the person mentally organizes information, whether and to what extent the communication style of the person corresponds to a deductive modality or an inductive modality;
with respect to how comfortable the person is at expressing himself or herself, whether and to what extent the communication style of the person corresponds to an extrovert modality or an introvert modality; and
with respect to whether the person presents information in a more linear manner or a more nonlinear manner, whether and to what extent the communication style of the person corresponds to a linear modality or a nonlinear modality.

9. The method of claim 1, wherein the instrument is a questionnaire and the set of responses comprises answers to questions in the instrument submitted by the person.

10. The method of claim 9, wherein the questionnaire comprises one or more of the following statements and asks the person to indicate whether he or she strongly disagrees, disagrees, agrees, or strongly agrees with each one:
I am less likely to actively participate in meetings with large numbers of people;
I am really good at anticipating details;
I am very annoyed when I attend meetings that lack a structured agenda;
I enjoy discussing theories and big ideas;
I find conversations not grounded in facts to be a waste of time;
I find it difficult to see the big picture without having all the details;
I like to develop and construct models to help explain my ideas;
I like to see multiple points of data before I will support an idea;
I like to take people down expected paths when presenting or preparing a presentation;
I make decisions based on research and data;
I make my case with evidence to better communicate my ideas;
I need to interact with colleagues or customers on a daily basis to be most productive;
I need to process information and develop ideas alone;
I need to see the big picture before I will support an idea;
I need to understand the big picture before diving into the details;
I need to use guidelines and operating procedures to support my position on issues;
I often lead meetings with a loosely structured agenda;
I prefer communicating in writing (e.g., email, instant messaging);
I prefer to be actively involved in meeting discussions;
I prefer to use a step-by-step process when helping others with their work;
I tend to focus more on the main idea rather than the details;
I trust my gut-level assessment of a situation;
I trust my intuition when solving problems;
I work best alone;
In meetings, I prefer to stay closely focused o the agenda;
In my opinion, meetings or group brainstorms are not as effective as individual efforts;
In preparing for a meeting or presentation, I work hard to anticipate every possible question;
My best ideas come from working with others;
My best solutions are based on data and evidence;
When delivering a presentation, I prefer to use a prepared outline;
When I am preparing a presentation I think in logical steps; or
When making a recommendation, I like to start with the main idea and then explain the supporting facts.

11. The method of claim 1, wherein the particular communication environment is defined at least in part by:
a purpose;
a format; and
how many participants are actively engaged.
the recommendation taking into account one or more of the purpose of the particular communication environment, the format of the particular communication environment, or how many participants are actively engaged in the particular communication environment.

12. The method of claim 11, wherein:
the purpose of the particular communication environment is selected from the group consisting of:
to inspire;
to educate;
to measure progress;
to plan;
to challenge thinking; and
to make one or more strategic decisions or correct course;
the format of the particular communication environment is selected from the group consisting of:
informing;
engaging; and
exchanging;
how many participants are actively engaged in the particular communication environment is selected from the group consisting of:
a few of the participants in the particular communication environment;
more than a few of and less than all the participants; and
all the participants in the particular communication environment.

13. One or more computer-readable storage media embodying software for execution by one or more processors, the software being operable when executed to:
access a set of responses to an instrument for assessing a communication style of a person, the instrument and the assessment focusing on:
how the person mentally processes information;
how the person mentally organizes information;
how comfortable the person is at expressing himself or herself; and
whether the person presents information in a more linear manner or a more nonlinear manner;
based on the set of responses to the instrument, determine a communication profile of the person that indicates:
how the person mentally processes information;
how the person mentally organizes information;
how comfortable the person is at expressing himself or herself; and
whether the person presents information in a more linear manner or a more nonlinear manner;
based on the communication profile of the person, generate a recommendation concerning communication by the person in a particular communication environment; and
communicate the recommendation for consideration.

14. The media of claim 13, wherein the recommendation is communicated for consideration by the person.

15. The media of claim 13, wherein the recommendation indicates how suited the communication style of the person is to the particular communication environment.

16. The media of claim 13, wherein the recommendation advises how to adapt the communication style of the person to the particular communication environment.

17. The media of claim 13, wherein:
the person is one of a plurality of candidate speakers for the particular communication environment; and
the recommendation advises whether to select the person from among the candidate speakers for the particular communication environment.

18. The media of claim 13, wherein:
the person is one of a plurality of candidate attendees for a particular meeting of a type corresponding to the particular communication environment; and
the recommendation advises whether to select the person from among the candidate attendees to attend the meeting.

19. The media of claim 13, wherein:
the person is one of a plurality of candidate team members for a particular working group using the particular communication environment; and
the recommendation advises whether to select the person from among the candidate team members to be included in the particular working group.

20. The media of claim 13, wherein the communication profile indicates:
with respect to how the person mentally processes information, whether and to what extent the communication style of the person corresponds to a conceptual modality or an analytical modality;
with respect to how the person mentally organizes information, whether and to what extent the communication style of the person corresponds to a deductive modality or an inductive modality;
with respect to how comfortable the person is at expressing himself or herself, whether and to what extent the communication style of the person corresponds to an extrovert modality or an introvert modality; and
with respect to whether the person presents information in a more linear manner or a more nonlinear manner, whether and to what extent the communication style of the person corresponds to a linear modality or a nonlinear modality.

21. The media of claim 13, wherein the instrument is a questionnaire and the set of responses comprises answers to questions in the instrument submitted by the person.

22. The media of claim 21, wherein the questionnaire comprises one or more of the following statements and asks the person to indicate whether he or she strongly disagrees, disagrees, agrees, or strongly agrees with each one:
I am less likely to actively participate in meetings with large numbers of people;
I am really good at anticipating details;
I am very annoyed when I attend meetings that lack a structured agenda;
I enjoy discussing theories and big ideas;
I find conversations not grounded in facts to be a waste of time;
I find it difficult to see the big picture without having all the details;
I like to develop and construct models to help explain my ideas;
I like to see multiple points of data before I will support an idea;
I like to take people down expected paths when presenting or preparing a presentation;
I make decisions based on research and data;
I make my case with evidence to better communicate my ideas;
I need to interact with colleagues or customers on a daily basis to be most productive;
I need to process information and develop ideas alone;
I need to see the big picture before I will support an idea;
I need to understand the big picture before diving into the details;
I need to use guidelines and operating procedures to support my position on issues;
I often lead meetings with a loosely structured agenda;
I prefer communicating in writing (e.g., email, instant messaging);
I prefer to be actively involved in meeting discussions;
I prefer to use a step-by-step process when helping others with their work;
I tend to focus more on the main idea rather than the details;
I trust my gut-level assessment of a situation;
I trust my intuition when solving problems;
I work best alone;
In meetings, I prefer to stay closely focused o the agenda;
In my opinion, meetings or group brainstorms are not as effective as individual efforts;
In preparing for a meeting or presentation, I work hard to anticipate every possible question;
My best ideas come from working with others;
My best solutions are based on data and evidence;
When delivering a presentation, I prefer to use a prepared outline;
When I am preparing a presentation I think in logical steps; or
When making a recommendation, I like to start with the main idea and then explain the supporting facts.

23. The media of claim 13, wherein the particular communication environment is defined at least in part by:
a purpose;
a format; and
how many participants are actively engaged.
the recommendation taking into account one or more of the purpose of the particular communication environment, the format of the particular communication environment, or how many participants are actively engaged in the particular communication environment.

24. The media of claim 23, wherein:
the purpose of the particular communication environment is selected from the group consisting of:
to inspire;
to educate;
to measure progress;
to plan;
to challenge thinking; and
to make one or more strategic decisions or correct course;
the format of the particular communication environment is selected from the group consisting of:
informing;
engaging; and
exchanging;
how many participants are actively engaged in the particular communication environment is selected from the group consisting of:
a few of the participants in the particular communication environment;
more than a few of and less than all the participants; and
all the participants in the particular communication environment.

25. An apparatus comprising:
a communication interface;
a memory comprising one or more instructions for execution by one or more processors;
one or more processors coupled to the memory and operable when executing the instructions to:
access a set of responses to an instrument for assessing a communication style of a person, the instrument and the assessment focusing on:
how the person mentally processes information;
how the person mentally organizes information;
how comfortable the person is at expressing himself or herself; and
whether the person presents information in a more linear manner or a more nonlinear manner;
based on the set of responses to the instrument, determine a communication profile of the person that indicates:
how the person mentally processes information;
how the person mentally organizes information;
how comfortable the person is at expressing himself or herself; and
whether the person presents information in a more linear manner or a more nonlinear manner;
based on the communication profile of the person, generate a recommendation concerning communication by the person in a particular communication environment; and
communicate the recommendation for consideration.
